(19) United States
(12) Patent Application Publication
(10) Pub. No.: US 2024/0242166 A1
(43) Pub. Date: Jul. 18, 2024

(54) Address Identification System

(71) Applicant: Adel Albazei, Riyadh (SA)

(72) Inventor: Adel Albazei, Riyadh (SA)

(21) Appl. No.: 18/562,126

(22) PCT Filed: Jan. 3, 2022
(86) PCT No.: PCT/SA2022/050002

§ 371 Date: Nov. 17, 2023

(51) Int. Cl. G06Q 10/083; G06F 21/62; G06Q 50/26

(52) U.S. Cl. CPC G06Q 10/083; G06F 21/6245; G06Q 50/265

(57) ABSTRACT

The invention relates to a system that issues a unique number to refer to the actual address with a processor that links the unique number with the actual address or group of addresses, wherein each actual address includes addresses with geographic basis, which include pair of latitude and longitude and at least street, postal address of buildings in addition to the relational data that determines the relations between different persons and identified address to the financial addresses. The unique numbers automatic linking mechanism include in each of them at least part of one actual address and name of the person linked to the actual address. The unique numbers are used to facilitate linking the actual address on geographical basis at least: street, postal address, and pair of latitude and longitude.

### BACKGROUND OF THE INVENTION

The scope of work in transporting packages and letters is not new; and the system that has been existing since introduction of this service depends on the matter that the consignor shall insert his/her name and address in addition to the name and address of the consignee. The consignor tries out the known couriers to recognize the better one that will deliver packages or letters quickly and safely. In addition, the e-trade companies depend on choosing the couriers, on which they will mainly depend on them in shipping products of e-trade to customers around the world. If the store conducts sale processes in various regions and countries around the world, choosing the appropriate courier out of several local or international couriers or even the global couriers will not be easy for the owners of the e-stores around the world.

It is necessary to clarify that one of the challenges that face most of the e-stores is to find an appropriate courier that can provide high quality services with the satisfying prices and facilities that will be widely suitable in addition to consideration of confidentiality of information of customers. It is worth noting that the courier, with which the e-store contracts with and depends on to deliver products is one of the factors and the most important elements that reflect the image of the store at customers. However, it is not possible to neglect privacy of customers, as any issues while shipping to the consumers or leakage of information can result in bad impressions at customers, which will result in turn in bad and insignificant shopping experience through the e-store. This will finally result in fall down of the number of visits for shopping on the e-store and fall down of percentage of sales and profits achieved by the e-store.

Indeed, the shopper on the e-store is shopping through the web by accessing the e-store website and choosing the products that he/she wishes to purchase with a trust in the e-store and a trust that the e-store has a reliable and honest courier that keeps information safe, especially addresses and personal information. Confidentiality of information and the method by which the courier deals with the customer's information in relation with the available services means having the maximum benefit with full trust that the courier and the e-store will afford all possible efforts to keep confidentiality of his/her information. Personal information are required or necessary in some web pages in order to verify identity of the customer and ensure his/her eligibility to use these services. Therefore, the courier and e-store shall take all necessary precautions to protect all information of the customer. When the customer uses the website, this means that he/she accepts the information confidentiality policy in addition to the terms of use in addition to collection, usage and storage of information of the customer as mentioned in the information confidentiality policy. This policy shall be effective upon using the website.

There were many news that the customers' information of well-known websites have been leaked. Many of customers hesitate of dealing with these companies. It has become necessary to find a method or system that keeps information of customers without misuse. The perfect method for solving this issue lies in enabling the customer to browse the website or shop online without disclosure of any private information. The information that is collected during normal usage of the website is the server record data of the website only, and can be used in dealing with another party upon providing new services; analyzing, storing or collecting information. In addition, the information can be used in dealing with another party, such as couriers, aiming at providing safe and sufficient services.

It is normally known that the customer provides his/her full personal information, which makes the customer is duly identified and known to the companies. If the customer wishes to provide the e-store and courier with the information, this will be considered as an approval on collection, transmission and storage of information on safe servers of these companies. The companies store the following information without limitation:
Email, contact details, and sometimes financial information;
Information on transactions based on activities of the customer on the website;
Access details, statistics of accessed pages, movements from and to the website, advertisements, other information including IP and record details on the internet;
Additional information from other parties (such as ID No., other information relating to customer's address or reply to additional questions for verification of identity of the customer); and
Additional or non-additional information to be added by the user for employment (such as CV, references . . . etc.).

This volume of information makes the customer fear of leakage of information, as one of the companies that keep his/her information may sell or rent his/her personal information to other parties for marketing purposes without explicit approval.

It has become necessary to innovate a method that ensure keeping confidentiality of information and addresses, as most of the customers purchase valuable items such as jewelry, art works and watches. Leakage of sale information and addresses will expose them to risk of theft. In addition, the system shall provide support to customers; provide the required information; prevent illegal activities; impose usage conditions; allocate, measure and improve the required services and confidentiality of information; and notify the customer if any authority requires the contact details of the customer. This system shall bear the full liability for the risk or loss resulting from leakage of information; and usage of the system and information. In addition, this system ensures avoidance of using the system or its contents for illegal purposes; sending, using, duplicating, publishing, allowing publish; whether defamatory, abusive, depraved, inappropriate, or violating confidentiality rights of any individual or applicable legislation; sending any undesired advertisement or promotion materials; and sending any messages that can interfere operations of this website. It shall be also liable for prohibiting internet users, whether individuals or non-registered companies, from using the system; or disclosing information of customers, which can result in a risk on the information in the system or its operating software; and disclosing personal information of the customer, unless disclosing to the entities approved by the service providers, which help under an entered contract in execution of trade transactions; other parties, from which the customer requires to send personal information to them; legal departments; and governmental authorities, pursuant to a verification request relating to criminal or illegal activity investigation. This system is global and can be used for the purpose of keeping confidentiality of information, and providing them to the reliable entities only.

### General Description of the Invention:

In respect of aspects of the present invention, the present invention provides a system that issues a unique number to refer to the actual address with a processor that links the unique number with the actual address or group of addresses. Each actual address includes addresses with geographic basis, which include pair of latitude and longitude and at least street, postal address of buildings in addition to the relational data that determines the relations between different persons and identified address to the financial addresses. The unique numbers automatic linking mechanism include in each of them at least part of one actual address and name of the person linked to the actual address. The unique numbers are used to facilitate linking the actual address on geographical basis at least: street, postal address, and pair of latitude and longitude.

In addition, the invention presents a method for identification of the real address of the user using the reference unique number including:
Initial transmitting processor is received through the website through a processing unit, coding unit, accounts creation units, information reference creation for contact reference, content reference using algorithm to identify the re-contact process through phone, email or SMS;
Storage device through the server system, contact signal to the content or the notifying party linked to the content;
Unit for requesting the identification documents to verify validity of relationship between the address and applicant in the customer's system;
Computer software that links information and provides a random unique number for the user consisting of: and
Contact network interface; through one or more networks, with smart devices or computer;
One or more processors;
One or more storage resources that store instructions to be inserted upon implementation by one or more processor.

When the invention receives, through one or more networks, a request to obtain a unique number with the actual address, the response to receive the request with the sentence (creation of a unique number for request to facilitate direct pairing between the unique number and actual address).

The system conducts a direct pairing with the operating software through one or more networks of the data of the unique number from application of the operating software on the customer's device of the operator.

Based on the data corresponding to the unique number, the user sends the data through one or more networks and corresponds data to the operating server to align and verify the identification papers

In addition, the invention provides a GPS system to create a process of configuration on the device used on the device linked to the network; and Provide a linking means between the user device and computer using the communication configurations to link the user device linked to network to the main system, as the user's device linked to the network receive a unique identifying code. The unique identifying code is created by the system and ensure that the user's device is allowed to access to the network to determine location of the user's device, which is the actual address of the user. The unique identifying code is used to facilitate re-creation of connection between the network and user's device.

The system creates a new connection through the main system between the network and the user's device using the unique identifying code including a response for inquiry. The response means that the new connection is created using the unique identifying code.

The system also provides a system that verifies identity of the user including a system that provide descriptive data responses to sound signals or image as a response to the user's response. The system consists of:

Initial database for biometrics (fingerprints, eye prints, face prints . . . etc.) on one computer, smart tablet or smart phone at least in order to receive an electronic form of the sound signal or image to record the biometric in the database of biometrics and record the same as a recorded biometric linked to the content identifier. It also includes a device for biometrics consists of programmed computer and linked to the biometric scanning device or smartphone with biometric configuration to be linked to the database to receive electronic copies and measure the recorded biometric of the electronic copy. In addition, it provides a recorded biometric on the database.

It also includes a data analyzer to identify the biometric including a programmed computer to receive first content identifier and identify descriptive data responses for the biometric with different collection processors to process the extracted corresponding digital codes; and to provide a descriptive data response for content identifiers in the digital codes. The processor consists of the following:
Database processor consisting of programmed computer that is formed to process databases linked to the content identifiers; and
Different recording interfaces with collection form to record different types of content identifiers for sound signals or images. The database processor is formed to identify the priority of responding to the descriptive data response between the different types of content identifiers.

In addition, the system provides a method and system for authentication and auditing of identification papers. It is the method that includes transferring the user's identity into a digital identity including the following:
System for sending emails or SMSs including coded holder key. The SMS identifies the feature of holder only maintained in the data storage of the digital identity system and storage location for the digital identity system. Copy of this is saved in the unique number file of the user;
Usage of the collection key to decode the received holder key; and
Mean to form an identity system into a digital identity, as a copy of this is saved in the storage location in the digital identity system, which is identified by the system. The remaining steps cannot be implemented unless the approval data is identified as valid by the digital identity system. The system includes the following:
Issuing an approval identity; linking identity approval data in the storage of the digital identity system;
The email is considered as a request for electronic sharing code to share identity with the system.

### BRIEF DESCRIPTION OF THE FIGURES

FIG. 1: General Graph of Unique Number System for Addresses.

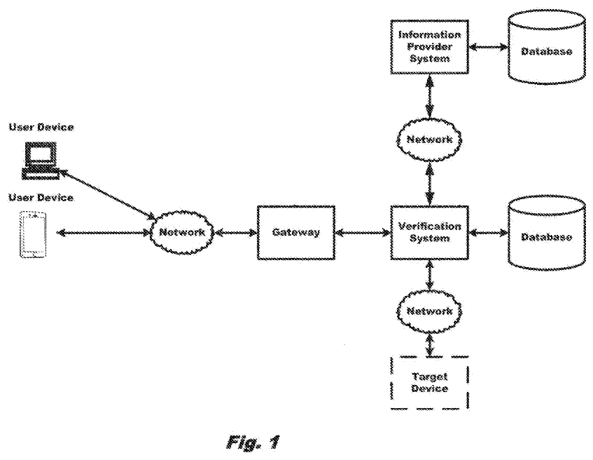

FIG. 2: General graph of components of the unique number system.

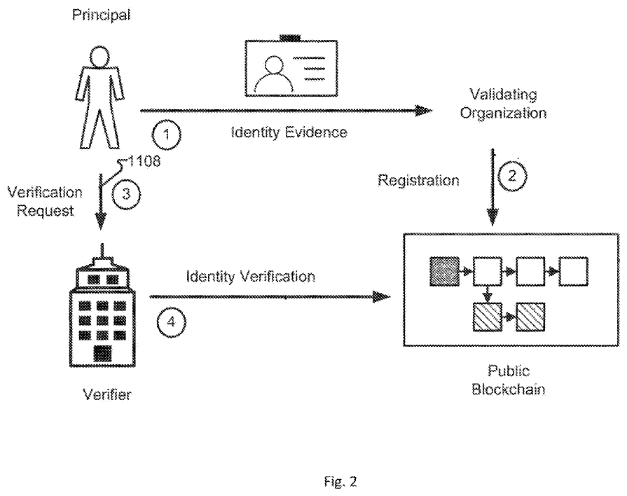

FIG. 3: General graph of components of verification system.

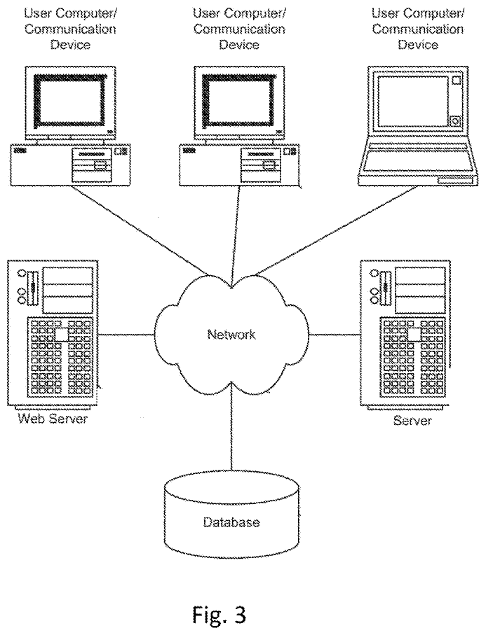

FIG. 4: General graph of the system.

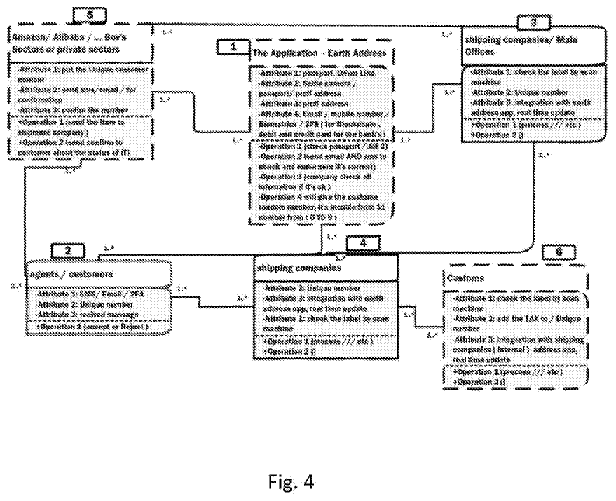

### DETAILED DESCRIPTION OF THE INVENTION

It is important in life to keep privacy data relating to each rational person on Earth from being misused by any person, gang, criminal organization . . . etc. Based on my experience and work nature in the information security and governance field for more than 22 years, I tried to find an idea of invention that is user friendly, not complicated, effective, and strong in protecting personal data and information from being hacked, misused or used in businesses without being aware by the concerned person; the authorized individuals. This invention depends on disguising identity of the first beneficiary (the authorized individual), which is mentioned in the data/information, in order to avoid reaching to any residence address/work address . . . etc./mobile numbers/home number/work phone number . . . etc./social media addresses. This invention depends on the following:
A. The system is available as an application on the global network-internet-available for any entity or user, whether individual/governmental authority/corporation/civil or military companies . . . etc. The beneficiary can use the coded address that consists of 11 cells of numbers 0 to 9 (unique number) (unrepeated), which will be given to the beneficiary in a random method based on certain algorithm.
B. Each address provides a random unique and unrepeated number with each new address.

In order that the beneficiary can obtain the unique number through the system, the following is required:
1—Recent copy of the valid passport; or
2—Copy of the valid national ID; or
3—Copy of the valid driving license;
4—Selfie photograph with any of the documents to be submitted through the system;
5—Residence address/home address/work address . . . etc. to be used in the application and to be documented at the official entity that gave the address;
6—Mobile number and email in order to receive verification through SMS;
7—Using biometrics (eye print/fingerprint/face print) for verification;
8—After the entity that gave the unique number verifies and checks the information and data of the beneficiary, and after verification of validity;
9—A code of 4 cells including correct numbers from 0 to 9 shall be sent through SMS;
10—A code of 4 cells including correct numbers from 0 to 9 shall be sent through email to the beneficiary in accordance with the record at the granting company;
11—The beneficiary shall insert the SMS in the cell on the system;
12—The beneficiary shall insert the SMS through email in the cell on the system;
13—If all the inserted code number are correct, the beneficiary will be given a unique number;
14—At the same time, the couriers shall be provided with a unique number relating to the beneficiary with a link to (the address of the beneficiary) through an approved network depending on the best recent techniques in transferring information through the global network (internet) in relation with information security and governance;
   (2) Entities that Provide Services to the Beneficiary
All entities (that do not have legal issues with the international system) that can benefit from company services through contacting with the direct system.
Upon purchasing a product, there shall be a unique number for the beneficiary to be inserted in the cell of the unique number.
If the unique number is correct:
   SMS with code shall be sent
   Email with code shall be sent
If the codes inserted are correct, a message shall be sent to the courier in order to perform the procedure.
In case of approval, a confirmation of the request shall be sent to the final beneficiary (consumer).

### (3) Courier

Verification shall be done through scanning+unique number.
Verification of the address through contacting the service provider.
Contacting the courier in the city of the final beneficiary.

### (4) Customs

Verification shall be done through scanning+unique number.
The unique number shall be linked to the residence or ID numbers for tax.

The present invention includes a system to generate a unique number linked to the actual address of each person, which is processed to record data of the user;
name, address, home location, work location . . . etc.;
Automated system to verify validity of the address, as the system requires from the user to prove that the inserted address is his/her own address;
Scan to insert the user identity including the address or the national address certificate, or any other mean to verify validity of the address;
Data processor to send a random automated number to the user;
Confidentiality maintenance system;
GPS to identify the address location;
Contact system that sends SMS or specific application to the user stating that he/she received SMS in addition to an automated system to the user to verify receipt or rejection based on the SMS that show information of the sender and content of the shipment;
In case of approval, the shipment shall be sent to the address on the system. In case of rejection, the sender shall be notified of the rejection of the beneficiary of receiving the shipment;
GPS system to follow-up the shipment; and
Alarm system to notify the customer of using his/her number or obtaining his/her information in addition to the inquiring entity; and a system to record the biometric print.

The system includes a biometric print that includes the following: Identification mean in the computer processor and linked to the user device in addition to an identification mean that is linked to the computer processor. It includes a method to identify level of dynamic security linked to requesting the procedure that identifies the user of the first devices. It also includes an identification mean in the computer processor, which is one or more groups of biometric access supported by the first device such as (fingerprint, eye print . . . etc.). It also includes an identification mean in the computer processor, which is one or more groups of biometric access that is registered by the user on the server of several devices; as the first and second devices are different. Each device shall be formed to collect physical biometric data directly from the user. It also has a device to update the level of dynamic security based on the information linked to the user and information related to the specified procedure. In addition, it includes a choosing option in the computer processor based on the specified dynamic security level. It also includes group of common biometric measures for the specified group for one or more method of biometric access methods supported by the first device in addition to the specified group of one or more biometric record methods that the user registered on the second device. It also has a dynamic change identification mean in the computer processor that is based on the specified dynamic security level, and limit of biometrics registration for each group of selected biometrics. The system includes a method to request the biometrics of the user in the computer processor for each group of selected biometric methods in addition to the methods of receiving the biometrics of the user on the computer processor for each group of the selected biometric methods.

In addition, the system includes a method in the computer processor to create a biometric degree for each received biometric, which is compared to the threshold of biometric registration relating to each group of selected biometrics. It also includes an identification mean, in the computer processor, for each of the selected biometric methods to identify, whether or not the generated related biometrics exceed the related threshold of biometric registration of each group of selected biometrics.

The system also include an identification mean to identify the level of dynamic security to the user identity or location of the first device of group of various devices; or type of the first device of several devices. The system also allows updating the level of dynamic security by increasing the dynamic security level, as the physical biometric data, that is directly collected from the user, is linked to a physical feature that is selected from group of sound, face, fingerprint, and iris.

From other aspect, the invention includes a method applied by the computer including:
Generating a unique number through groups of various blocks at least through:
Maintaining a multiplicity of number counters for a logical group of storage devices from a group of knots, which include a group of the following:
Receiving the data that is required to be stored on the logical group of the storage devices of the system;
Identifying the value of the single counter for multiple digits;
Creating a unique identifier for the data element that matches the date based on the value of the single counter at least;
Unique identifier for logical collection of the storage devices of the group in order to ensure avoidance of repetition of the same number; and store the data element using the unique number of the data element. The data element is not changeable after forming the unique identifier of the data element. The matching copies of the data element shall be identified through the same unique identifier.

In addition, the invention provides a server that consists of:

Processor that can store information including one or more units of configuring software in order to send messages to the device of the customer. This message will provide instructions to the destination to reach to the server to confirm registration in addition to a mean to receive one or more messages from the customer's device. It also receive one or more messages including the unique number originated by the server to the destination; and file identifier that identifies the identity, payment information and actual address. It also receives one or more authentication messages from the customer's device through searching for the identifying number, storing device, storing transaction identifier linked to the unique number in the database, which matches the nickname and transaction identifier in one or more messages. In addition, it has one or more authentication messages from the customer's device to provide information about confirming registration and creation of the targeted account that is linked to information of the user in addition to address, identity and biometric print.

The system also include one or more software units as an additional unit for storage and linking of stored information of the user in the database. One or more units will be formed of the software units as additional to receive the unique number that is originated by the server in order to retrieve information of the account from the database. It also has a mean to identify the transaction identifier from the group of email, mobile number, serial number, numeric alphabetic serial, retails identifier, URL, coded URL, coded serials and group of this; in addition to a mean that allows the user to retrieve data of account. The account name is the email or mobile number.

The system of the unique number linked to the actual address includes a system to process data consisting of one or more servers and application software that includes instructions that can be implemented by the operations system to contacting devices of the user; and can receives requests of the user from the user devices. It also has a system to transfer requests into tasks or functional instructions; processor for flow of updates and instructions that can be implemented by a processor that is dedicated for receiving tasks and functional instructions. It implements two or more instructions of the contradicting instructions related to tasks of functional instructions through working on the data in the stored database.

In addition, it includes a system that is linked to the application software that refers to ensuring implementation of the task.

It implements instructions that is potential to be contradicting in a way that maintains consistency of data in the database.

The system also include a processor to update one or more operations of creation of files and applicable instructions through operations for creation of a file including two or more potential contradicting instructions. The system ensures that there are instructions that can be implemented by the processor of updates flow in order to maintain consistency through the synchronized processing related to the specified and other data. This allows linking the system with any commercial transaction through e-trade.

The system also include a system to provide descriptive data responses for an attached image or one taken by camera. The system consists of:
Preliminary database for biometric that consists of one computer at least, which is formed to receive an electronic copy of the biometric in the data base of initial fingerprints as a registered print that is linked to the first content identifier;
Identification mean to identify the fingerprint consisting of one programmed computer; analyzer of biometric in contact with the database; and a mean to receive the electronic copy and fingerprint account that is registered for the electronic version. It provides the registered fingerprint of the database. The registered fingerprints are formed of registered secondary fingerprints from parts of the electronic copy with the registered fingerprints linked to the first content identifier;
Database for fingerprints that is formed to receive secondary fingerprints that are extracted from sound signal or sensible image that is sensed from the mobile of the applicant. The first database of fingerprints is formed to obtain the first content identifier that matches the registered secondary fingerprints that match the extracted secondary part-fingerprints.

The identifier analyzer is formed of a programmed computer that is formed to receive the first content identifier and identify the first descriptive data responses at least corresponding to the first content identifier. The identifier analyzer is formed in larger way with collecting processors to receive the second content identifier from the device of the applicant; and to identify the second descriptive data response that at least corresponds to the second content identifier. The second content is given a unique number;
Databases processor from the programmed computer that is formed to process databases linked to the first and second content identifiers; and identify priority responses to the first and second descriptive data, which will be provided to the device of the applicant. A database processor is formed to determine priority of the first and responses of the second descriptive data based on priorities of the first and second content identifiers;
Different registration interfaces with a collection form to register different types of content identifiers in order to receive images. The database processor is formed to identify the priority of the descriptive data response among different types of content identifiers; and
Block of responses that consists of a programmed computer, which is formed to form the descriptive data response from the first and second descriptive data responses based on outputs of the database processor. It is formed to provide a compound descriptive data response for the presentation on the applicant. The unique number system is used on a platform to have a unique number that is linked to the actual address and payment information in addition to any other personal information; and to receive, through a processor in a recording device on the computer, data of transactions relating to the unique number, which is created by the entity that manages the globally-recognized identifiers. The listed unique identifier includes data of the first identifier, as the issuing entity originates the identifying unique number, and the second identification data originates the unique number. The records storing entity is independent from the blockchain that records dealing of the unique number. There is a records storing entity in the computer software relating to addresses and customers' data responding to one request linked to one or more auditing; hacking block process; identifying the regulating structure in addition to the frequencies of using the unique number. The unique number also includes a security code and unique CUSIP identifier, unique ISIN identifier or unique CINS identifier.

The system ensures that, in case of hacking, if the unique number is stolen by a intrusive or network hacker, the unique number that is stored on the identifier includes a mean to provide instructions from the records storing entity to the platform to cease or cancel the hacked unique number; and provide instructions to the platform to create an alternative unique number.

In addition, the system includes a storing medium that can be read by a computer to perform the following processes:
Implementation of one or more instructions by one processor at least resulting in one processor at least will perform the following:
Determination of the actual address linked to the unique number, which will be a reference to be used by the user;
Determining the location identifier of the site (home, work, factory . . . etc.);
Originating a reference (unit number and apartment);
Determining a research area of the location identifier to identify the district or the number of the building; and
Allowing the user to insert the address manually or through GPS function from device of the user.

The system also allows to record more than one unique number to one address; for example, the location can be a building consisting of several floors and apartment or family members residing at the same location. The system also includes a system that has a storing medium for data in addition to a control unit for storage of data that is formed to identify that the present section inside the data storage medium is in usage to identify a valid determination for a location in the present section to one or more addresses. It also duplicates the data from the site to the new storing location in the data storing medium.

It retrieves the location from the present section; determine insertion of one or more in the first table that includes group of inserts. Each insert or inserts in the first table include a reversal identification of the address in the data storing medium to one or more virtual addresses. It also identifies that the first table includes a valid identification of the address. It identifies that the determination is a valid response to identify the first table that includes at least one valid identification of address. A data storing unit is formed to maintain a second table that includes group of inserts. Each group of inserts in the second table identifies the specific address of the location in the data in the memory. The system includes a tool to remove repeated data. There will be a data storage control unit in relation with the data of the locations as an additional response to identify data for avoidance of repetition.

The system also includes a data linking and allows the permitted entities to request the stored data including the data server that can be accessed by large number of users that are listed in the list of trust of the users that are reliable and authorized to access to one or more files.

The trust management driver sends an email that includes a link to one or more files that can be transferred to each user in the list of trust of the reliable users. The email is stored on the server of the email independent from the data server. It is easy through the trust management driver to send a message through email, SMS or authentication software.

The email is sent from the system to the first user and prevents access of any other user if sent to another user. It has an identification method to identify, whether or not the user is listed in the list of trust, as it stores one or more users that are trusted by the unique number owner.

Storage of the first transferrable file in the data storage is linked to the first trust list; creation of non-transferrable email or SMS to the owner of the unique number to confirm access of the reliable entity to his/her data; and to receive a request from the trust management driver from a user in the trust list that are trusted to access to one or more files by the unique number owners as a response to identify linking in the email. The file data storage is one of many files data storages that is corresponding to various group of trust lists of the reliable users.

The system include a computer interface and device processor that is formed to implement identification of the digital identity. The digital identity is formed upon implementation on the processor to perform processes including the following:
Creation of an electronic sharing code. The request of the unique code identifies at least one of the features of the holder in the digital identification data storage; sends a request for unique code to the digital identification system through the computer interface; receives data from the digital identification system; and responds to the electronic code. It provides a unique sharing code for this request to be presented by the holder to the auditor. It makes the unique sharing code available for the auditor. It leads to presenting the unique sharing code to the digital identification system by the auditor to provide the feature of one holder at least for the auditor through digital identification system. The unique sharing code is received with an encoding sharing key for one holder feature at least. The application is formed to provide the auditor with a sharing code. The email can be created as a response to receiving selected group of one holder feature at least from device of the holder through the user interface of the holder device. the application is formed to present a sharing code to be available through barcode on the device screen that is included in the email sent to the digital identification system. The application is formed to present a copy of the policy that is available to the auditor with sharing code in addition to non-transferrable storage mediums that can be read by the computer and is formed to store the instructions that can be implemented. Upon implementation on one or more processors of the devices in the digital system, one or more processors of the devices are configured to implement the following:
Receiving the request for electronic sharing code from the holder in the digital identification system, as the request is identified in the data storage as one feature at least for the selected holder to be shared with the auditor;
Responding to the request for electronic code; creating sharing code, which is unique for this request to be submitted by the holder to the auditor;
Linking the unique sharing code in the digital identification system to the specified holding feature at least; and
Originating the unique code of the user.

Provision of a unique code, in a later time, to the digital identification system by the auditor will lead to availability of one holder feature at least linked to the sharing code to the verification entity through digital identification system or biometric.

1.-8. (canceled)

9. A system that issues a unique number to refer to an actual address with a processor that links the unique number with the actual address or group of addresses;
wherein each actual address includes addresses with a geographic basis, which includes a pair of latitude and longitude coordinates and at least street, postal addresses of buildings in addition to relational data that determines relations between different persons and identified addresses to financial addresses;
wherein a unique numbers automatic linking mechanism includes in each of them at least part of one actual address and name of a person linked to the actual address;
wherein the unique numbers are used to facilitate linking the actual address on a geographical basis including at least one street, postal address, and pair of latitude and longitude coordinates;
wherein the system for identification of the real address of a user using the reference unique number includes:
an initial transmitting processor received through a website through a processing unit, coding unit, accounts creation units, information reference creation for contact reference, content reference using an algorithm to identify a re-contact process through a phone, email or SMS;
a storage device through a server system, contact signal to the content or a notifying party linked to the content;
a unit for requesting identification documents to verify validity of a relationship between the address and an applicant in a customer's system;
computer software that links information and provides a random unique number for the user consisting of:
a contact network interface, through one or more networks, with smart devices or a computer;
one or more processors; and
one or more storage resources that store instructions to be inserted upon implementation by the one or more processor.

10. The system according to claim 9, further comprising means for verifying an identity of the user including a system that provides descriptive data responses to sound signals or images as a response to the user's response.

11. The system according to claim 10, further comprising:
a database for biometrics on one computer, smart tablet or smart phone in order to receive an electronic form of the sound signal or images to record the biometrics in the database for biometrics and record the same as a recorded biometric linked to a content identifier; and
a device for biometrics including a programmed computer and linked to a biometric scanning device or smartphone with a biometric configuration to be linked to a database to receive electronic copies and measure the recorded biometrics of the electronic copies.

12. The system according to claim 9, wherein the system provides a recorded biometric on a database.

13. The system according to claim 9, further comprising:
a data analyzer to identify biometric data including a programmed computer to receive a content identifier and identify descriptive data responses for the biometric data with different collection processors to process extracted corresponding digital codes and to provide a descriptive data response for content identifiers in the digital codes.

14. The system according to claim 13, wherein the collection processors include any one of:
a database processor including a programmed computer that is configured to process databases linked to the content identifier; and
different recording interfaces with collection forms to record different types of content identifiers for sound signals or images;
wherein the database processor is configured to identify a priority of responding to the descriptive data response between the different types of content identifiers.

15. The system according to claim 9, further comprising a system for authentication and auditing of identification papers.

16. The system according to claim 15, wherein the system for authentication comprises:
a system for sending emails or SMSs including coded holder keys;
wherein the SMS identifies a feature of a holder only maintained in a data storage of a digital identity system and storage location for the digital identity system;
wherein a copy of this is saved in a unique number file of the user;
wherein usage of the collection key permits decoding of the received holder key; and
means to form an identity system into a digital identity, as a copy of saved in the storage location in the digital identity system, which is identified by the system;
wherein any remaining steps cannot be implemented unless an approval data is identified as valid by the digital identity system;
an issuing system for an approval identity; and
a linking system for linking the identity approval data in the storage of the digital identity system;
wherein the email is considered as a request for an electronic sharing code to share the identity with the system.
